(19) United States
(12) Patent Application Publication
(10) Pub. No.: US 2008/0166694 A1
(43) Pub. Date: Jul. 10, 2008

(54) Plant tissue packaging process

(76) Inventors: Michael Weber, Sunnyvale, CA (US); Ray Hoobler, Pleasanton, CA (US); Paul Dick, San Jose, CA (US); Randy McLaughlin, Wenatchee, WA (US)

Correspondence Address: CARR & FERRELL LLP, 2200 GENG ROAD, PALO ALTO, CA, 94303, US

(21) Appl. No.: 11/881,522

(22) Filed: Jul. 26, 2007

Related U.S. Application Data
(60) Provisional application No. 60/879,716, filed on Jan. 9, 2007.

(51) Int. Cl. A01N 1/00

(52) U.S. Cl. 435/1.1

(57) ABSTRACT

A method is provided for packaging harvested plant tissues, such as agricultural products. Embodiments of the present invention mitigate damage to harvested plant tissues due to excessive ripening and spoilage, by contacting the plant tissues with ozone during transportation and storage. For example, in some embodiments harvested plant tissues are placed in substantially closed modified atmosphere packages, and the packages are surrounded by an atmosphere containing ozone. In alternative embodiments, the packaging may be perforated, and the packages placed in a controlled atmosphere that contains ozone. Harvested plant tissues may be treated with ozone before packaging further to promote their freshness. The present invention thus increases the longevity and value of harvested plant tissues beyond the abilities of currently available packaging methods.

### CROSS-REFERENCE TO RELATED APPLICATIONS

The present application claims benefit and priority from U.S. Provisional Patent Application Ser. No. 60/879,716 filed on Jan. 9, 2007, Attorney Docket # PA4101PRV entitled, “Improved Modified Atmosphere Packaging Process,” which is herein incorporated by reference.

### BACKGROUND OF THE INVENTION

1. Field of the Invention

This invention relates to packaging for harvested plant tissues.

2. Description of Related Art

Many plant tissues, including important agricultural products, ripen after harvest. For example, bananas harvested green and unripe continue to ripen during packaging, transportation and storage, consuming oxygen and releasing carbon dioxide in the process of respiration. Bananas also produce ethylene (although not all fruits do), and exposure to ethylene promotes the ripening of harvested bananas and other climacteric (ethylene-sensitive) fruits.

Agricultural industries are vulnerable to economic losses from the excessive ripening or spoilage of agricultural products before those products reach the consumer. Many important agricultural products are harvested unripe or partially ripe to avoid damage, spoilage or decay en route to market. The storage and transportation environments for these products must be optimized for the products' preservation.

Technology that slows or effectively suspends ripening during the transportation and storage of plant products can reduce or prevent losses of the products due to overripening and spoilage. Further, technology that mitigates ripening can broaden the market horizons for agricultural and horticultural products, by allowing them to reach more distant consumers due to their improved longevity during transportation, or by allowing them to remain in storage longer before becoming unpresentable to consumers. For example, ripening-mitigation technologies may afford fruit and vegetable growers greater access to consumers in lands to which their products must travel by sea. Ripening-mitigation technologies may also extend the green-life, shelf-life, and effectively the season of availability of notoriously perishable fruits.

“Green life” refers to the period of time after harvest during which the plant product stays in a condition suitable for transportation. “Shelf life” refers to the period of time after the green life during which the product remains saleable. For example, upon arrival at an overseas shipping destination, green bananas are often processed in ripening rooms, in which ethylene is administered to achieve the plant products' uniform partial ripening before delivery to the retailer and consumer. For each type of plant product, there are conditions that typically induce ripening. For example, green bananas ripen while exposed to ethylene at a concentration of 100-150 parts per billion in a room held at 20 degrees Celsius and 90-95 percent relative humidity.

Currently available technologies for lengthening the duration between harvest of plant products and their presentation to consumers, such as postponing or slowing ripening, include: harvesting fruit well before it is ripe, refrigeration, packaging fruit in “modified atmosphere” containers to retard respiration, and adding a powder that absorbs ethylene. Modified atmosphere packaging is a commonly used technique for preserving agricultural products, in which the oxygen content of the atmosphere inside a package is changed to retard respiration and other undesired processes. For example, hard, green (“preclimacteric”) bananas may be packaged in modified atmosphere packaging such as polyethylene bags that are 0.4 mm thick, in which the carbon dioxide content has been raised to five percent, and the oxygen content has been lowered to two percent. Potassium permanganate may be enclosed in the packaging to absorb ethylene emitted by the bananas. When stored in this manner and refrigerated at approximately 12 to 14° C., preclimacteric bananas shipped at a relative humidity of about 90 to 95 percent may enjoy a shelf life of about two to three weeks.

Refrigeration alone preserves plant products by slowing ripening and the growth of decay-causing microbes. Reduced-oxygen or controlled-atmosphere storage enhances the benefits of refrigeration. Controlled-atmosphere storage is a commonly used technique in which the oxygen content of the atmosphere inside a storage area is changed to promote the preservation of harvested agricultural products; the concentrations of other gases, temperature and humidity of the storage area are routinely controlled as well. Controlled-atmosphere storage requires specially equipped storage rooms that are costly to construct and operate, and maintaining a controlled atmosphere in a shipping container is very difficult and expensive. Moreover, because controlled-atmosphere environments do not support human life, they may only be entered by personnel with special equipment. In addition, ethylene-sensitive products (such as kiwi fruit) and ethylene-producing products (such as Oriental Pears) must be stored in separate rooms to prevent cross-ripening. Furthermore, even when a batch of ethylene-sensitive fruit is stored separately from other fruits, an entire batch of ethylene-sensitive fruit (e.g., all the fruit in a storage room or shipping container) can ripen prematurely if only a small amount of the fruit within it begins to ripen and induces “cross-ripening” by emitting ethylene.

Modified atmosphere packaging provides a low-oxygen environment to its contents, allowing them to be stored or transported in a regular-atmosphere environment. It would be desirable to use modified atmosphere packaging for ethylene-sensitive products, so that these products could be stored and shipped in proximity to ethylene-producing products, minimizing concerns of cross-ripening (and cross-contamination of other kinds) between separately packaged products. However, undesired ripening and microbial contamination within each package remains problematic. The packaging traps ethylene, which thus accumulates within the package. The rate of ripening of ethylene-sensitive plant products in packaging that traps ethylene is faster than that which occurs in storage conditions that allow ethylene to escape. Even if the packaging has some permeability to ethylene, the rate of transfer out of the package is limited, leading to increased ethylene concentrations inside. Also, permeation of ethylene out of the package is limited if the difference in concentration on the inside and the outside is small, for example, due to ethylene buildup in the volume in which the packaged product is stored.

What is desired is a method of more effectively retarding or arresting ripening and spoilage during the transportation and storage of harvested plant tissues. The present invention provides an improved technology to mitigate the excessive ripening and spoilage of plant tissues.

### SUMMARY OF THE INVENTION

A method is provided for packaging harvested plant tissues, such as agricultural products. Embodiments of the present invention mitigate damage to harvested plant tissues due to excessive ripening and spoilage, by contacting the plant tissues with ozone during transportation and storage. In some embodiments harvested plant tissues are placed in substantially closed modified atmosphere packaging, and the packages are surrounded by an atmosphere containing ozone. In alternative embodiments, the packaging may be perforated, and the packages placed in a controlled atmosphere that contains ozone. Harvested plant tissues may be treated with ozone before packaging further to promote their freshness. The present invention thus increases the longevity and value of harvested plant tissues beyond the abilities of currently available packaging methods.

### BRIEF DESCRIPTION OF THE DRAWINGS

FIG. 1 is a diagram of an exemplary embodiment of a plant tissue packaging process according to the present invention.

FIG. 2 is a diagram of another exemplary embodiment of a plant tissue packaging process according to the present invention.

### DETAILED DESCRIPTION OF THE INVENTION

The present invention utilizes ozone as a component of the atmosphere to which packaged plant products are exposed, such as the atmosphere surrounding packaged fruit or vegetables in a cold storage room or in a shipping container. Applying ozone gas to the atmosphere inside a storage room or shipping container in a controlled range, typically from about ten parts per billion to about ten parts per million, with a preferred range being between about fifty parts per billion and about one part per million, allows ozone to penetrate the packaging and destroy ethylene, as well as to destroy or slow the growth of microorganisms and fungi inside the package, on the package and in the storage container. Ozone also can reduce the transfer of oxygen through the packaging, lowering the diffusion of oxygen from the surrounding atmosphere into the package and thus further assisting in the mitigation of ripening. Ozone also reduces ethylene in the environment outside the package, increasing the concentration gradient of ethylene, and thus facilitating transfer of ethylene out of the package.

A variety of configurations for contacting the ozone with the packaged plant products fall within the scope of the present invention. For example, the ozone may permeate substantially closed, gas-permeable packaging to reach the plant products, or the packaging may be perforated so that gases flow more easily between the inside and outside of the packaging. The packaging may also optionally be gas-impermeable packaging that includes a gas-transfer patch, which may comprise a polymer or other membrane (for example, an INTELIMER® patch by Landec Corporation, Menlo Park, Calif.).

In some embodiments, ozone is added to a refrigerated container. The container need not be a controlled-atmosphere container. Ozone added even to a standard-atmosphere refrigerated container will permeate polyethylene bags loaded into the container and change the atmosphere in contact with the plant tissues inside the bags. Ozone significantly delays or slows ripening of climacteric fruit, destroying the ethylene inside the package; reducing the influx of oxygen into the packaging may also contribute to this effect. In addition, the antimicrobial and antifungal properties of the ozone in contact with the plant tissues and with the packaging provide an added benefit towards maintaining the packaged produce in good condition. Ozone does not introduce any detriment to the food or other positive qualities of the packaged plant products, and when the packaging is opened in a regular atmosphere, it disappears without a residue.

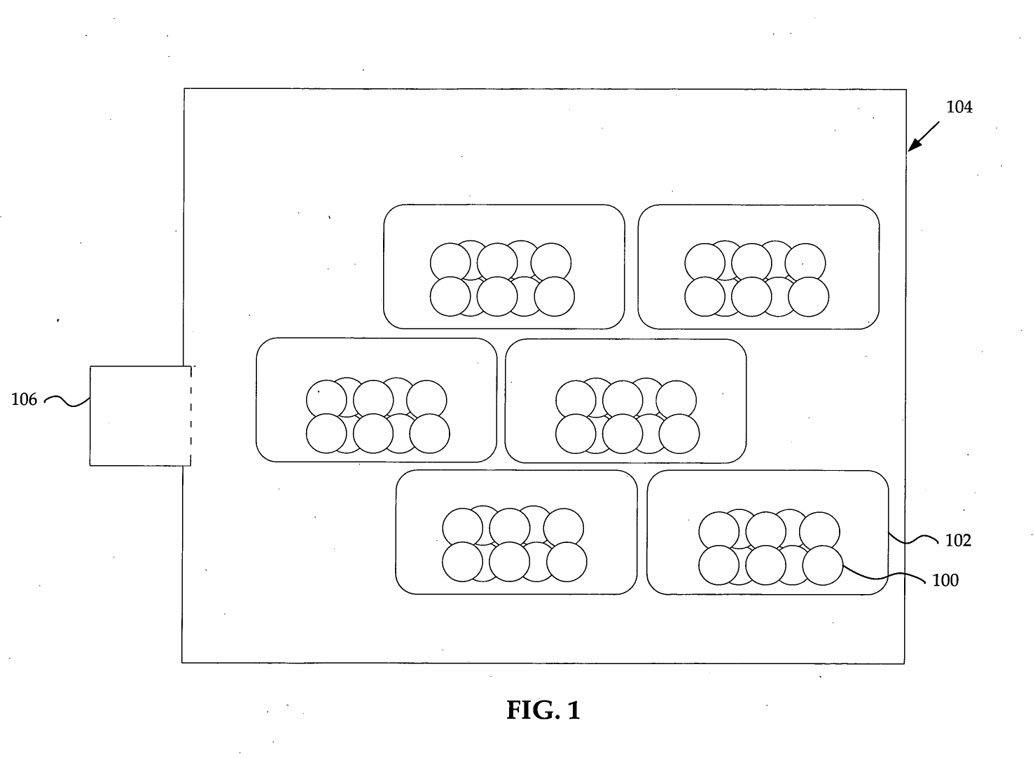

FIG. 1 is a diagram of an exemplary embodiment of a plant tissue packaging process according to the present invention. In this embodiment, plant tissues 100 such as climacteric fruits (for example, apples or bananas) are stored in packages 102, such as those made of a single material (for example, polyethylene bags). The packages 102 are in turn stored in a shipping container 104 that is in communication with an ozone generator 106, which adds ozone to the atmosphere inside the container 104. The ozone generator 106 may be any kind of ozone generator, and the addition of ozone to the atmosphere in the container 104 may be regulated by any means. For example, a system that measures ozone concentrations in the atmosphere and provides feedback control to regulate the activity of the generator may be used, so that the ozone concentration in the atmosphere is maintained, increased, or decreased according to a predetermined or dynamically updated atmospheric ozone level.

In an exemplary embodiment, bananas are stored in polyethylene bags, each of which is tied closed with a knot. Such a plastic bag may be described as being “substantially closed” or “substantially sealed,” in that it is not perforated. However, the polyethylene is permeable to certain gases, such as oxygen, carbon dioxide, ethylene and ozone, which therefore can still move between the inside and outside of the bag. The rate of gas transfer through the bag is determined by the difference between the concentrations of the gas inside the bag and in the atmosphere surrounding the bag, as well as by the permeability of the bag. Ethylene, in particular, has a low permeability through polyethylene bags, and its concentration inside a bag can increase substantially with time. For example, the air in a container carrying bananas in polyethylene bags that are tied closed in this way does not show a significant increase in ethylene, which apparently remains inside the bags.

Typically, such substantially sealed polyethylene bags containing bananas are loaded into a standard refrigerated container. Respiration by the packaged bananas decreases the oxygen concentration in the bags, and the combination of refrigeration and reduced oxygen concentration slows respiration and ripening of the packaged bananas. However, if the ethylene concentration inside the bags increases, it will promote ripening of the bananas despite the low oxygen concentration and temperature of the bags' contents.

Adding ozone to plant products in substantially sealed packages also allows the packages to protect the plant products from cross-ripening by ethylene emitted from sources outside the package, or present in the environment outside the package, and from cross-contamination by pathogens or other harmful materials from sources external to the package, while eliminating the disadvantages arising from ethylene accumulation inside the substantially sealed packages.

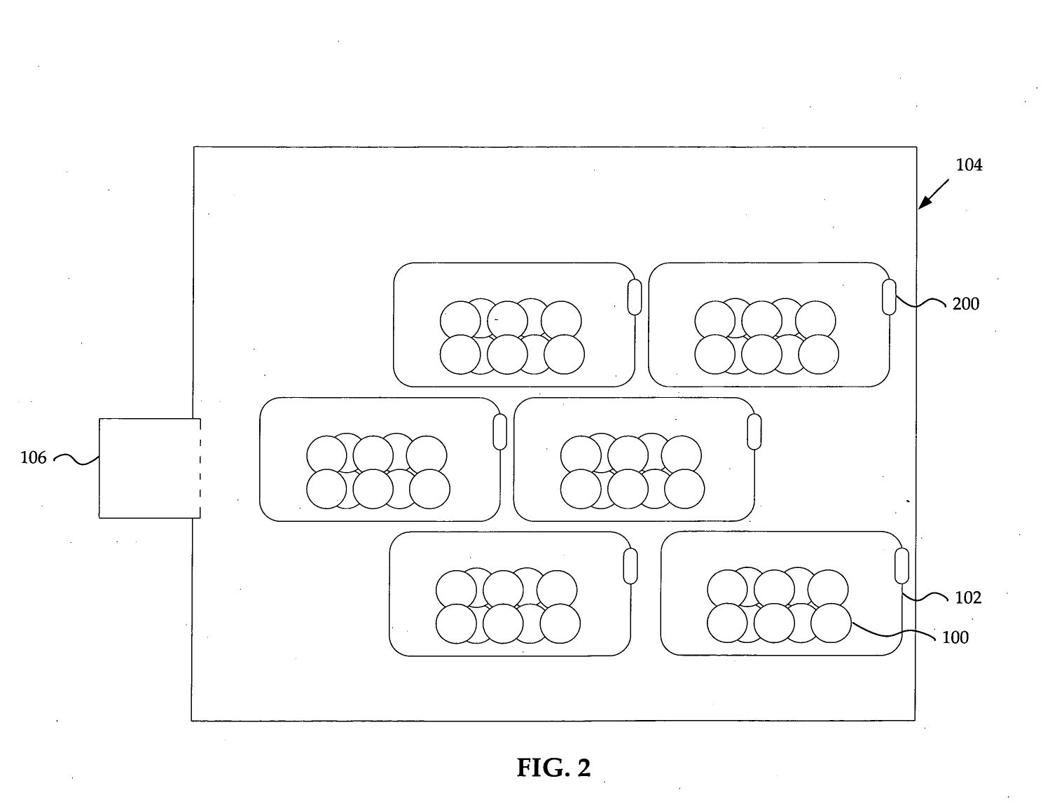

FIG. 2 is a diagram of another exemplary embodiment of the invention. As described above, if desired, the plant tissues may be packaged in gas-impermeable packaging that includes a gas-transfer area. In this embodiment, the plant tissues 100 are stored in packages 102 that have an area 200, such as a patch, that controls gas exchange with the environment. Here, the package 102 may be effectively gas-impermeable, and the area 200 may have perforations or be made of a material through which gas transfer is possible (such as a gas-permeable polymer).

Appendix A is a table summarizing the conditions of an experiment demonstrating the benefit of some embodiments of the present invention. Experimental conditions included loading harvested Cavendish bananas in polyethylene bags (known as “banavac” bags) into two containers, both having a regular atmosphere (containing 20.8 percent oxygen), with vents partially opened for the first four weeks and completely closed for the last four weeks of the experimental period. The experimental difference between the containers was the maintenance of 200 to 300 parts per billion of ozone in Container 7, and the absence of ozone from Container 8.

Container 8 in the experiment detailed in FIG. 3 was loaded with bananas in modified atmosphere packaging (here, polyethylene bags tied closed with a knot). The bananas were stored in the container without added ozone. At 56 days after harvest, all of the bananas were spoiled to the point of liquefaction. The putrefied bananas thus were exposed to the control conditions of the experiment, which did not offer the benefit of some embodiments of the present invention.

Container 7 in the experiment detailed in FIG. 3 was loaded with bananas in modified atmosphere packaging (here also, polyethylene bags tied closed with a knot). According to an embodiment of the present invention, the bags of bananas in Container 7 were exposed to a surrounding atmosphere containing an ozone level of 200 to 300 parts per billion. The experimental conditions resulted in the bananas' markedly superior condition compared to that of the control bananas after 56 days of storage.

In another embodiment, a controlled-atmosphere shipping container is filled with bananas packaged in perforated bags, and ozone is added to the controlled atmosphere. If a non-ozonated controlled-atmosphere container is well sealed, ethylene will accumulate, offsetting the benefit of slowed respiration afforded by the controlled atmosphere. The addition of ozone according to some embodiments has been shown to delay climacteric ripening of bananas and to reduce overall ethylene levels in controlled-atmosphere and regular-atmosphere containers.

Ozone may be added to storage or shipping containers by any method, for example, by using an Advanced Refrigerated Transport System (ARTS), available under the brand name “purFresh” (Novazone, Inc., Livermore, Calif.). This system provides means for ozone generation, ozone measurement, and ozone level control, as well as logging of environmental data and remote communication. Any mobile or stationary storage or shipping containers, such as those used for transport by sea, truck, rail and air, may benefit from the present invention. The storage rooms or containers need not be controlled-atmosphere containers. The containers may be ozonated individually, or in some cases, such as ship holds, may be ozonated using a central system. Embodiments of the present invention are applicable at any of one or more points in the chain of storage and transport of plant tissues from the point of harvest to the point of use.

In some embodiments, plant tissues also are treated with ozone before the products are packaged, for example, by exposure of the plant tissues to ozone gas or to ozonated water, for instance, in a hydro-cooler. Such ozone pre-treatment affords additional benefits, such as destroying or retarding the growth of microorganisms on or around the plant products even before ozone is introduced to the atmosphere in which the packaged plant tissues will be loaded.

It will be understood by one skilled in the art that embodiments of the present invention are applicable to many plant tissues, including but not limited to climacteric products, such as kiwi fruit, Oriental Pears, and harvested bananas. The advantages and immediate usefulness of some embodiments of the present invention are evident in that, for example, these embodiments can increase the green life of bananas shipped in packages by at least five days. An additional benefit of embodiments of the present invention is that ozonation serves as an antimicrobial and antifungal treatment, reducing damage to or destruction of packaged plant tissues from microbial and fungal sources. Ozone also has the benefit of reducing microbial populations on the outside of the package and on the walls and refrigeration components of the storage environment.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for preserving harvested plant tissues, the method comprising:
placing the plant tissues in a package; and
surrounding the package with an atmosphere containing ozone.

2. The method of claim 1, further comprising refrigerating the packaged plant tissues.

3. The method of claim 1, further comprising exposing the plant tissues to ozone before placing the plant tissues in a package.

4. The method of claim 2, wherein the package is made of a modified atmosphere packaging material.

5. The method of claim 4, wherein the concentration of ozone is in the range of approximately ten parts per billion volumes to approximately ten parts per million volumes.

6. The method of claim 5, further comprising placing the packaged plant tissues within a ship hold.

7. The method of claim 5, further comprising placing the packaged plant tissues within a shipping container or storage room.

8. The method of claim 6, wherein the plant tissues are fruits or vegetables.

9. A method for preserving harvested plant tissues, the method comprising placing the plant tissues in a package; and surrounding the package with an atmosphere containing ozone, wherein the package is made of a modified atmosphere packaging material.

10. The method of claim 9, wherein the package is a substantially closed polyethylene bag.

11. The method of claim 10, further comprising refrigerating the packaged plant tissues.

12. The method of claim 11, further comprising placing the packaged plant tissues within a shipping container or storage room.

13. The method of claim 12, wherein the plant tissues are fruits or vegetables.

14. The method of claim 13, further comprising exposing the plant tissues to ozone before placing the plant tissues in a package.

15. A method for preserving harvested plant tissues, the method comprising placing the plant tissues in a package; and surrounding the package with an atmosphere containing ozone, wherein the atmosphere is a controlled atmosphere.

16. The method of claim 15, wherein the gas concentration that is controlled in the atmosphere comprises that of oxygen.

17. The method of claim 16, wherein the concentration of ozone is in the range of approximately ten parts per billion volumes to approximately ten parts per million volumes.

18. The method of claim 17, wherein the package is perforated.

19. The method of claim 18, further comprising refrigerating the packaged plant tissues.

20. The method of claim 19, further comprising exposing the plant tissues to ozone before placing the plant tissues in a package.
